(19) United States
(12) Patent Application Publication
(10) Pub. No.: US 2007/0227748 A1
(43) Pub. Date: Oct. 4, 2007

(54) Fire Retarded Flexible Nanocomposite Polyurethane Foams

(76) Inventors: John Liggat, Glasgow (GB); Richard A. Pethrick, Glasgow (GB); Ian Rhoney, Glasgow (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/571,181

(22) PCT Filed: Jul. 1, 2005
(86) PCT No.: PCT/GB05/02600

§ 371 Date: Jun. 6, 2007

(30) Foreign Application Priority Data
Jul. 2, 2004 (GB) 0414850.8

(51) Int. Cl. C08G 18/76; C08G 18/48; C08J 9/00; C08K 3/34

(52) U.S. Cl. 169/45; 422/133; 521/55

(57) ABSTRACT

The present invention relates generally to flexible polyurethane foam compositions that incorporate partially and/or totally exfoliated, clay based nanocomposite material. The invention also relates to the foams formed from the compositions, the preparation of the foams and uses thereof.

### FIELD OF INVENTION

The present invention relates generally to flexible polyurethane foam compositions that incorporate partially and/or totally exfoliated clay based nanocomposite material. The invention also relates to the foams formed from the compositions, the preparation of the foams and uses thereof.

### BACKGROUND TO INVENTION

Polymeric foam materials are known for a variety of uses. For example, polymer foams are used for insulation in building, in cushioning in automotive seating and in sound damping and related applications.

An important factor in determining the use of a polymer foam material is the degree of fire retardancy of the foam. Materials such as unmodified polyurethane foams burn easily to release toxic fumes. It is therefore desirable to have polyurethane foams that resist combustion when ignited and/or which release lower amounts of toxic and/or environmentally undesirable fumes.

Presently, flame retarding agents have been used as additives to foam compositions to minimise combustion. However, flame retardants can compromise the desirable physical properties of the final foam material. Flame retardants which contain halogens or phosphorous based compounds may also be undesirable due to toxicity implications and environmental impact.

Although the use of clay as an additive to polymer materials as a flame retardant has been considered, [Polymer—Layered Silicate Nanocomposite with Conventional Flame Retardants, J. W. Gilman T. Kashiwagi, Polymer Clay Nanocomposites, Ed. T. J. Pinnavaia G. W. Beall, 2000, Wiley and references therein], the use of clay as a flame retardant in polyurethane foam materials has not been reported. Materials containing dispersed exfoliated clay particles are generally known as nanocomposites.

U.S. Pat. No. 6,518,324 describes the use of a nanoclay material in a foam composition, and in a foam made from the composition. The patent reports that the incorporation of a nanoclay material improves the thermal insulation properties and affects the cell structure, to give a fine cell foam structure. However, for a cellular polyurethane foam to be an insulating material it must have a ‘closed’ cell structure, in contrast to a flexible foam, which must have an ‘open’ cell structure. The patent suggests therefore that the foam produced thereby has a different structure to existing foam materials which do not incorporate a nanoclay. The physical properties of a foam may be closely affected by the foam cell structure and no indication is given in the patent on whether the resultant foam can simply replace existing foam materials, or if the properties of conventional foams are retained. The patent indicates that the foam produced thereby has a fine closed cell structure caused by incorporating the nanoclay. Clearly the nanoclay has an effect on the foam structure, and has achieved an effective barrier to the loss of the halogen containing foaming agent from the closed cell structure, achieving an improvement in the thermal insulation characteristics of the rigid polyurethane foam.

An important property for flexible foams for use in seating is the comfort characteristic to the user. It is desirable for this characteristic to be maintained in fire retardant foams used for seating applications.

There is a need for foam materials having good fire retardant properties which are easily made, substantially retain the physical properties of conventional foam materials, and minimise the amount of fire retarding chemical additives used in the foams.

It is an object of the present invention to obviate and/or mitigate at least one of the above mentioned problems.

It is a further object of the present invention to provide a flame retardant nanocomposite polymer foam which at least partially retains the physical properties of conventional polymer foams.

It is yet a further object of the present invention to provide a process for producing nanocomposite polyurethane foam compositions and flexible polyurethane foams formed therefrom.

### SUMMARY OF INVENTION

According to a first aspect there is provided a mixture for use in forming a foamed polyurethane said mixture comprising components necessary for forming a polyurethane foamed material, clay particles and at least one coupling agent.

The components necessary for forming a foamed polyurethane generally comprise at least one polyol and/or amine, an isocyanate, a catalyst, a surfactant and water and/or a blowing agent.

According to a second aspect of the present invention there is provided a flexible foam material comprising a polyurethane composite material, wherein the polymer composite material comprises exfoliated clay particles dispersed therein and at least one coupling agent.

Desirably the mixture or composite material further comprises a char promoting agent and/or fire retardant. Suitable char promoting agents include melamine, ammonium polyphosphate, trichloropropyl phosphate (TCPP), triethyl phosphate (TEP), diethyl ethyl phosphate (DEEP) and diethyl bis(2 hydroxyethyl)amino methyl phosphonate. Suitable fire retardants include brominated phthalic anhydride based ester, dibromoneopentyl glycol, brominated polyether polyol and aluminium trihydrate or similar alternatives.

The term “polyurethane composite material” is defined herein as a polyurethane material having dispersed therein exfoliated clay particles. It is to be understood that the term exfoliated clay particles relates to clay particles which have been disrupted by suitable energy, which will be described in more detail hereinafter, to overcome the interactions between clay platelets. The exfoliated clay particles includes particles which have been partially disrupted i.e. not all interactions between particles have been overcome and/or fully exfoliated clay particles in which all interactions between clay particles have been overcome.

The term “foam material comprising a polyurethane composite material” is generally defined to mean that a foam material is formed of a polyurethane composite material.

Advantageously, such foam materials generally require little or no, or at least, less flame retarding agents due to the clay particles dispersed therein.

Although zero amount of flame retarding agent is preferred, it may be advantageous to incorporate a char promoting agent such as melamine and/or a fire retardant agent, as described above.

It has been observed by the present inventors that the incorporation of a nanoclay material into a polymer foam composition to obtain the final foam material can be difficult. In particular it can be difficult to obtain the desirable properties of the comfort characteristics found in conventional foams which do not contain nanoclay material. It is thought that this may be due to the reinforcing effects of the exfoliated clay particles on the polyurethane resin resulting in the reinforcement of the mechanical properties observed as an increased hardness of the foam. Moreover, such exfoliated clay particles may affect thin film formation during formation of the foam material. Compensation for the effects of increase in hardness accompanying the incorporation of the exfoliated clay can be achieved by adjustment of the polyurethane matrix characteristics.

Effective exfoliation of clay particles improve the gas barrier properties of the foam and enhances char formation under combustion conditions. The exfoliated clay particles appear to reduce oxygen ingress into the foam matrix and reduce volatile product egress from the foam. However incorporation of exfoliated clay particles can result in a high viscosity of the composition, particularly the low shear viscosity, resulting in compromised rapid mixing of the composition. Rapid and even mixing of a foam composition prior to foam formation can be important to ensure a homogeneous mixture of reactants is achieved before substantial foaming starts; this ensures as much as possible that a homogeneous foam material is formed with an even cellular distribution and a uniform dispersion of the exfoliated clay platelets.

The use of a coupling agent advantageously provides a polyurethane foam composition having a viscosity desirable for manipulating the composition prior to foam formation, while maintaining at least some dispersed clay particles therein.

Clay materials are natural or artificial minerals comprising particles in the form of platelets, and include smectite, vermiculite and halloysite clays.

The smectite type can be further categorised into montmorillonite, saponite, beidellite, nontrite, and hectorite.

An artificial clay material is for example laponite.

A preferred clay material for use in the present invention is a montmorillonite clay which is an aluminosilicate clay of formula:
M⁺_{y}(Al_{2-y}Mg_{y})(Si₄)O₁₀(OH)₂nH₂O

Suitable montorillonite clays for use in the present invention may be obtained commercially under the trade name Cloisite® e.g. Cloisite® 6A, Cloisite® 15A, Cloisite® 20A, Cloisite® 10A, Cloisite® 25A, Cloisite® 30B and Cloisite® Na⁺. These are termed organically modified clay materials but may or may not incorporate an organic modifier.

Typically the amount of incorporated into the foam composition is generally between above 0 to about 20% by weight of the total foam composition weight.

The amount of clay may be from about 0.1% to about 15% by weight of the total foam composition weight.

Preferably the amount of incorporated clay is from about 1% to about 10% by weight of the total foam composition weight, e.g. 8% by weight of the total foam composition weight.

The nanoclay materials comprise platelet particles.

Typically the exfoliated nanoclay platelets have a thickness of around 1 nm and a size in the planar direction of around 0.01 μm to 100 μm.

Each individual platelet particle may have a length/thickness ratio of around 200-1000.

The ideal dispersion would be completely exfoliated clay platelets but enhancement over existing foams may be achieved with partially exfoliated clay particles.

The platelets generally aggregate together with the planar surfaces adjacent, into stack structures. The space between the platelets in these stacks is generally known as a gallery. The separation of the platelets across the gallery is generally of the order of 3-5 Å. In organically modified clay particles the gallery separation has been increased to a value of the order of 18 Å.

In a preferment, the clay minerals have undergone a cation exchange with at least one cationic organic species.

For example, sodium ions on the surface of the clay particles may be exchanged with the cationic organic species.

The cationic organic species may comprise for example a quarternary ammonium ion species or an onium species.

Examples of suitable quaternary ammonium ion species include alkyl ammonium ions, e.g. dimethyl dihydrogenatedtallow ammonium, which has the following formula:

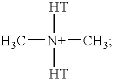

dimethyl benzylhydrogenatedtallow ammonium, which has the following formula:

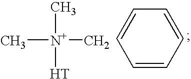

dimethyl hydrogenatedtallow (2-ethylhexyl)ammonium, which has the following formula:

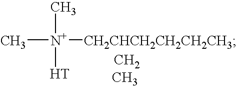

and methyl bis 2-hydroxylethyl ammonium, which has the following formula:

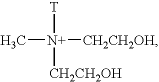

where, in each of the above formulae, T=tallow and HT=hydrogenatedtallow having a chain length with an approximate content of 65% C₁₈, 30% C₁₆ and 5% C₁₄.

Without wishing to be bound by any particular theory, the inventors believe that the cationic organic species modify the surface of the clay particles. The inventors believe that the organic modifier changes the hydrophobicity of the platelet surface thereby enabling better dispersibility of the platelet particles within a hydrophobic polymer material.

Accordingly, the use of a cationic organic species may enhance the compatibility of the clay particles with the polymer material.

Furthermore, the gallery space separation of clay platelets may be increased through treatment with a cationic organic species to allow the polymer material to enter the gallery space. This may advantageously result in an increased dispersibility of the platelets within the polymer material.

Further increases in gallery spacing and movement of the platelets away from a stack structure results in further dispersion of the platelet particles within the polymer material and this is termed herein as exfoliation.

Organic cationic species are described in U.S. Pat. Nos. 5,530,052 and 5,773,502 which are incorporated herein by reference.

The inventors of the present invention have also found advantageous use of a so-called coupling agent with the clay materials.

Coupling agents are known and are described in S. J. Monte and G. Sugerman, Kenrich Petrochemicals Inc and A. Damusis and P. Patel Polymer Institute University of Detroit, “Application of Titinate Coupling Agents in Mineral and Glass Fibre Filled RIM Urethane Systems,” SPI Urethane Div, 26^{th} Annual Conference (November 1981). Polyurethanes with inorganic fillers, Nippon Soda Co Ltd, Jpn Kokai Tokkyo Koho JP 60, 71625 28 Sep. 1983. all of which are incorporated herein by reference. The coupling agents are described as reducing the viscosity of various polymer compositions.

Without wishing to be bound by any particular theory, it is proposed that the coupling agent is able to add to positive sites on the edges of the clay particles which results in blocking the formation of viscosity enhancing ‘house of cards’ platelet structures.

Advantageous coupling agents for use in the present invention comprise neoalkoxy titanate or neoalkoxy zirconate agents.

Particularly advantageous is the neoalkoxy titanate agent, neopentyl(diallyl)oxy tri(dioctyl)phosphate titanate which has the formula (I) indicated below, and is known by the tradename LICA® 12.

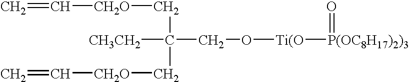

The coupling agent may be incorporated into a foamed polyurethane composite material at an amount of above 0 to about 10% by weight of the total foam composition weight.

An amount of coupling agent of from about 0.001% to about 6% preferably 0.005 to 2% of the weight of the clay in the total foam composition may be used.

Typically, polyurethane foams may be made through the use of external addition of a gas in situ on generation of the polyurethane or a combination of these two mechanisms.

The foam-forming gas or a gas precursor material is generally known as a blowing agent.

Preferred foam compositions are those in which the gas for forming the foam is generated in situ. For example the gas may be generated through chemical reaction of a constituent of the foam forming composition.

Preferred polyurethane formulations of this type are polyurethanes that generate carbon dioxide gas on mixing the starting materials required for forming the polymer.

The term “polyurethane foam” used herein refers to an open-celled flexible product obtained by reacting a polyisocyanate with isocyanate-reactive hydrogen containing compounds and a foaming agent.

In particular, the foaming agent or the blowing agent generally used for a polyurethane foam is carbon dioxide, which is generated by the reaction of water with isocyanate groups to give urea linkages and a polyurea-urethane foam.

The isocyanate reactive compounds may be chosen from polyols, aminoalcohols and/or polyamines.

Examples of polyols include reaction products of alkylene oxide, for example ethylene oxide and propylene oxide; polyesters obtained by the condensation of glycols and higher functionality polyols with polycarboxylic acids; hydroxyl terminated polythioethers; polyamides; polyesteramides; polycarbonates; polyacetals; and polysiloxanes. Other isocyanate-reactive compounds include ethylene glycol, diethylene glycol, propylene glycol, dipropylene glycol, butane diol, glycerol, trimethylolpropane, ethylene diamine, ethanolamine, diethanolamine, triethanolamine, pentaerythritol, sorbitol, sucrose, polyamines such as ethylene diamine, tolylene diamine, diaminodiphenylmethane and polymethylene polyphenylene polyamines, and aminoalcohols such as ethanolamine and diethanolamine and mixtures thereof.

A flexible polyurethane foam may be prepared by reacting a polyisocyanate with a relatively high molecular weight isocyanate-reactive polymer, e.g. a polyester or polyether polyol, in the presence of a blowing agent and typically including additives such as catalysts, surfactants, fire retardants, stabilisers and/or antioxidants.

Suitable surfactants would include polyoxyalkylene polysiloxane copolymers or related materials.

The flexible foam may be prepared according to the one-shot process where the urethane and urea reactions occur simultaneously or using the quasi or semi prepolymer or prepolymer processes. In the latter the polyol is first reacted with an excess of isocyanate and the resulting isocyanate prepolymer reacted in a second step with water and the other additives. [The Polyurethane Handbook, D. Randall and S. Lee, John Wliey & Sons, 2002.]

Flexible foams prepared by the reactive mixing of an isocyanate with a polyol and/or amine may be used to produce moulded foams or generate slabstock foams for use for example as cushioning material in furniture and automotive seating, in mattresses, as carpet backing, foam in diapers, packaging foam, or sound insulation foam.

Polyisocyanates for use in the present invention include any of those known in the art for preparing polyurethanes. For example, aliphatic, cycloaliphatic, aryl-aliphatic and aromatic polyisocyanates.

Examples of aromatic polyisocyanates include toluene diisocyanate e.g. toluene 2,4-diisocyanate and toluene 2,6-diisocyanate and mixtures thereof; diphenylmethane diisocyanate e.g. the 2,4′-, 2,2′- and 4,4′-isomers, polymeric isocyanates and isocyanurates, thereof and mixtures thereof, including oligomers thereof.

The present invention in a third aspect provides a method of making a flexible foam material comprising:

providing a mixture comprising components required for forming a foamed polyurethane, clay particles for dispersion within said foamed polyurethane and at least one coupling agent; and forming the mixture into a flexible foam material.

The mixture is as previously defined above and may further comprise additional preferred components as described hereinbefore.

The mixture may be provided according to any suitable technique. The inventors have found that the fire retardant properties of the foam composite material benefit from incorporation of clay material which has been subjected to high shear mixing with at least one of the components required for forming the foamed polyurethane e.g. the polyol.

It is suggested that this observation is linked to the degree of dispersion or exfoliation of the clay particles within the polymer composition.

High shear mixing may be achieved with a mechanical mixer such as an ultra turrax mixer. However the inventors observed that mechanical mixing alone may not optimise the dispersion of the clay particles into an exfoliated state.

Advantageously, the use of ultrasound in the presence or absence of mechanical stirring, provides an effective means for dispersion of the clay particles within the foam composition into an exfoliated state.

Preferably, the ultrasound is applied as high frequency ultrasound. The frequency range will typically be in the range 1 kHz to 10 MHz but will preferably be in the kilo hertz frequency range.

The ultrasound may be applied simultaneously with mechanical mixing.

The ultrasound may be applied for a period of time sufficient to achieve desired exfoliation. Depending on the type of process being adopted this could be between for example 0.1 seconds to 2 hours.

Typically in a small batch process the ultrasound is applied for a period of time of from 10 seconds to 30 minutes.

Preferably the ultrasound is applied for a period of time of from 30 seconds to 20 minutes, e.g. 15 minutes.

Alternatively, microwaves, infrared radiation or other electromagnetic radiation may be applied to the nanocomposite formulation to achieve dispersion and exfoliation of the clay particles.

Without wishing to be bound by any particular theory, the effective dispersion of the clay particles in the composition is believed to be associated with the ability to couple energy selectively into molecular species which are capable of supplying the necessary energy to overcome the interactions between the clay platelets. In the case of ultrasound, the frequency chosen is preferably that which is associated with binding of water molecules to inorganic species and the hypothesis is that these molecules are selectively excited by the ultrasound which results in exfoliation of the clay particles. Similar mechanisms for the provision of energy to the galleries may be used with other selective forms of irradiation.

According to a fourth aspect of the present invention there is provided a process for preparing a pre-polyurethane composition comprising the steps of:

providing a polyol,

introducing a clay material into the polyol and applying ultrasound to form a dispersed mixture, and introducing water, a polyisocyanate and optionally at least one coupling agent into said dispersed mixture to form a final prefoamed polyurethane composition and allowing the prefoamed polyurethane composition to polymerise and form a polyurethane foam nanocomposite material.

For example, following foam formation, the foam is allowed to cure to form a final polyurethane foam nanocomposite material.

The term “prefoamed-polyurethane” as used herein relates to a composition which is capable of forming a polyurethane polymer and/or a polyurethane polymer foam upon polymerisation of the prefoamed-polyurethane.

The water maybe added before, at the same time, or after the introduction of the polyisocyanate.

The resultant combination of components may be mechanically mixed prior to foam formation.

Prior to forming the foam nanocomposite material, the composition is usually introduced into a mould to contain the composition during foam formation, or allowed to form a free foaming slab.

At least one of the above mixing steps may be carried out simultaneously with the introduction of the composition into the mould or into a free foaming slab form.

Typically, the composition is introduced into the mould or slab forming structure by means of a reaction injection moulding device.

Preferably a coupling agent as defined hereinbefore is introduced during the preparation process.

Preferably the coupling agent is provided in the polyol containing mixture.

The composition may additionally contain other additives, such as catalysts, surfactants, flame retarding agents, stabilisers, colourants and antioxidants.

Typically, these other additives are provided in the polyol containing mixture.

Preferably, the mixture to which the ultrasound is applied is stirred and cooled during the application of the ultrasound.

The clay particles may comprise any of the clay materials described herein above.

Preferably the polyisocyanate is based on methylene diphenyl diisocyanate or toluene diisocyanate.

As an embodiment of the fourth aspect there is provided a means for preparing a prefoaming-polyurethane composition.

The means is particularly advantageous for preparing the prefoaming-polyurethane composition immediately prior to its introduction into a mould or reaction injection moulding device.

The means generally comprises a first chamber or region (A) into which is introduced a polyol and clay particles, and optionally a coupling agent and/or other additives such as a char promoting agent;

ultrasound, and optionally mechanical stirring, is applied to the mixture in chamber or region (A) to disperse the clay particles;

the resultant mixture may then optionally be moved into a second chamber or region and water and an isocyanate added in an appropriate order, with optional mechanical mixing to form the prefoaming-polyurethane composition.

Alternatively, the mixing of the constituents may be achieved by use of a mixing head in which all reactants are mixed simultaneously and ultrasound or other suitable dispersing energy applied.

The ultrasound is advantageously delivered by means of an ultrasound generating probe.

According to a fifth aspect of the present invention there is provided a polyurethane foam material obtainable by the process according to the fourth aspect.

According to a sixth aspect of the present invention there is provided use of a clay material as a fire retardant in a polyurethane nanoclay foam composite or foam nanocomposite material.

### DETAILED DESCRIPTION OF THE INVENTION

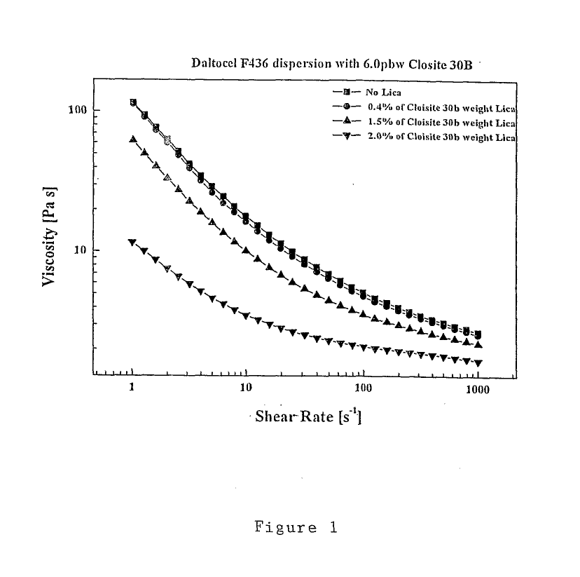

Embodiments of the present invention will now be described by way of example only, and with reference to FIG. 1 which shows a graph of the results of viscosity measurements at different shear rates for a dispersion of Cloisite® 30B in a particular polyol Daltocel [F436], Huntsman Chemical, with different amounts of LICA®.

General Experimental Details

A study on the exfoliation of the nanoclay particles in the polyol component was undertaken. Ultrasound and active stirring of the liquid polyol were found to achieve good exfoliation of the dispersion of clay particles by monitoring the rheology of the dispersion. The quality of the dispersion was indicated by the extent to which the viscosity of the medium was enhanced.

The edge to face interactions between the exfoliated platelets lead to an enhancement of the low shear viscosity.

The viscosity of the particular polyol was increased from a value of about 1 Pas to a value in excess of 100 Pas. Whilst the enhancement in viscosity indicated an exfoliated clay state, it produces a problem in relation to achieving effective rapid mixing with the isocyanate prior to the foaming process. It was therefore desirable to decrease the viscosity of the polyol while retaining an exfoliated state of the clay platelets. This was achieved by the addition of the coupling agent LICA®. It is suggested that the LICA® selectively adds to the positive sites on the edges of the clay particles and blocks the formation of the ‘house of cards’, three dimensional interacting structure associated with the viscosity increase.

It appears that the use of LICA® results in exfoliated clay particles which tend to be aligned face to face rather than edge to face.

The viscosity of the resultant mixture was reduced by the addition of LICA® to about 10 Pas which is sufficiently low for effective mixing with the isocyanate. The results of viscosity measurements at different shear rates for a dispersion of Cloisite® 30B in polyol with different amounts of LICA® is shown as a graph in FIG. 1, in which the concentration of Lica is expressed as a percentage (%) of the weight of Cloisite® 30B.

Small Scale Production of Nanocomposite Polyurethane Foam.

A small-scale duplicate of a large scale method for producing the polyurethane formulations was developed.

Moulds were constructed having internal dimensions of 130 mm×130 mm×40 mm.

The formulations used were typical of those used for the production of car seats and are based on methylene diphenyl diisocyanate (MDI). A toluene diisocyanate based system is an alternative, and sometimes preferable, but is more toxic than MDI.

The aim was to form a self-creaming foam which had the desired skin and foam cell structure which closely matched that obtained in large scale production.

To compensate for the adiabatic heating that occurs during large scale production, the cure of the samples was carried out in an oven at 40° C.

From the study it was apparent that incorporation of the clay into the formulations has a dramatic effect on the foaming process. This appeared to be due to the effects of the surface activity of the clay particles and the ability to modify the diffusion of the gas that forms the foam. A matrix of experiments was undertaken in which the conditions used in the mixing, the amounts, times of addition of the catalysts, and amounts and types of the surfactants were systematically varied.

Foams were created which had a very similar cell structure to those formed without incorporation of partially exfoliated clays. However, the foams with the partially exfoliated clays were harder than the typical car seat foams, and further optimization of the isocyanate to polyol ratio and blending of the materials was necessary to achieve a foam of equivalent flexibility to that in a foam that contained no partially exfoliated clays.

Formulations were produced which allowed the creation of foams with clay levels above 0 to 10% parts by weight of the total composition weight whilst still retaining the intrinsic foam and mechanical properties of conventional foams.

The foams produced in the small scale method had essentially the same mechanical properties as those of the commercially produced car seat supplied and yet partially exfoliated clay was incorporated to levels shown in Table 1.

The compressibility and density of the foams were used as guide criteria for optimization of the produced foams. In order to produce slightly softer, more flexible foams than those produced using the initial formulation, an alternative polyol was used or the ratio of the polyol to the isocynate altered. By changing the molar mass and functionality of the polyol it was possible to change the glass transition temperature of the foam material. Furthermore, changing the ratio of the isocyanate to polyol can vary the modulus. These criteria enabled a material to be produced with essentially the same mechanical characteristics of those for a car seat foam.

In a large scale manufacture, the foam formulations would generally be reaction injection moulded hence the requirement to maintain a viscosity which allows reaction injection moulding to be achieved. High viscosities of formulations prevent effective reaction injection moulding to be used.

Although the small scale study did not use an reaction injection moulding apparatus, a system was used which had a propeller mixture to ensure that the mixture was continuously moved through the volume being subjected to irradiation with ultrasound.

The obtained foams were examined by professional foam makers who indicated that the foams were very similar to those produced on a large scale.

Flammability Testing

Pieces of the foam were cut to approximately 13 mm×13 mm and 100 mm long. The pieces were placed on an open wire gauze and held with the longitudinal axis horizontal. The test apparatus was housed in an enclosed laboratory hood free of induced or forced draft during the test procedure. The enclosed laboratory hood was fitted with a heat resistant glass window for observing the test and an exhaust fan for removing the products of combustion after completion of the test.

A laboratory burner with a 20 mm high blue flame was used as the ignition source. The burner was positioned such that the central axis of the burner tube was in the same vertical plane as the longitudinal bottom edge of the piece of foam and inclined at 45 degrees to the horizontal. The flame was allowed to impinge on the test piece of foam for 20 seconds without changing the flame position, and then withdrawn so that there was no effect on the test piece after 20 seconds.

The following data were recorded: 1) test piece weight; 2) burn time; 3) burn distance; and 4) test piece residue weight.

The test is based on a fire-test-response test method covering a small scale laboratory screening procedure for comparing the relative linear rate of burning or extent and time of burning of plastics in the form of test pieces held in a horizontal position.

The test showed that conventional car seat foam material burnt very rapidly under the conditions and the foam material melted into the flame zone and was rapidly consumed. The degradation of the material was characterised by a highly mobile melt and bubbling as volatiles were released. The flame front was immediately behind the degradation zone with very rapid and near complete degradation to volatile species, with little char formation. The degradation products dripped through the gauze.

In comparison, the incorporation of 8 parts by weight of Cloisite® 30B nanoclay into a foam significantly decreased the rate at which flame propagation occurred. In this case the melt state was less mobile and dripping did not occur. The flame front lagged behind the degradation zone which is indicative of a slower volatile release profile, and more char was formed.

It was found that a formulation with 8 parts by weight of nanoclay and 30 parts by weight of melamine, which is a fire retardant, gave a foam which was almost self extinguishing. Other formulations were investigated which contained nanoclay in combination with other fire retardants such as tri-phenyl phosphate, Reofos NTP and Reofos 50. The foam materials of these formulations were found to have flammability characteristics not significantly better than a foam containing only nanoclay.

The flammability testing demonstrated that effective incorporation of a nanoclay into a foam formulation to produce a foam resulted in a significant improvement of the fire retardant characteristic of the foam compared to foam which did not include nanoclay.

Polyurethane foam incorporating exfoliated nanoclay based on other isocyanates, such as toluene diisocyanate, are anticipated to also exhibit enhanced fire retardant properties similar to those demonstrated with MDI.

Detailed Experimental Examples

A comparative polyurethane foam was prepared according to the following procedure:

The formulation contained 60.0 parts Suprasec 2528, a polymeric methane diphenyl diisocyanate available from Huntsman Chemicals; 100 parts Daltocel F428 (Huntsman Chemicals); 0.70 parts Dabco BL11, a reagent containing 70% Bis(dimethylaminoethyl)ether and 30% dipropylene glycol; 0.04 parts Dabco 33LV both catalysts available from Air Products; 0.58 parts Dabco DC5169 a silicon stabilizer surfactant from Air Products; 0.52 parts B-4113 a surfactant (available for Goldsmidt Chemical Corporation); 8.0 parts Cloisite® 30B (available from Southern Clay Products); 0.16 parts LICA® 12 a coupling agent (available from Kenrich Petrochemicals Inc.); 3.6 parts water as blowing agent; all parts are by weight of the total mixture. For the foam without nanoclay, the polyol, catalysts, surfactants, water were mixed in a container, followed by addition of the MDI. The mixture was vigorously stirred and poured into a mould.

A polyurethane foam containing 8.0 parts by weight of the monoclay Cloisite® 30B was prepared according to the following procedure:

A container was prepared by washing with a 3.0% solution of LICA® 12 in xylene. Into the dry container was added the polyol, catalysts, surfactants and coupling agents as indicated for the comparative polyurethane foam above, and the solution mixed. The nanoclay was added and the mixture sonicated for 15 minutes using a Cole Palmer Ultrasonic Processor with ¼ inch tapered probe and operating with 40% attenuation for a period of 15 minutes, the dispersion being stirred and cooled during the sonicating process. After sonication 3.6 parts water was added to the dispersion and the dispersion stirred vigorously for 3 minutes. 60 parts Suprasec 2528 was added to the dispersion and the mixture stirred vigorously for 10 seconds before being poured into a mould.

Further formulations were prepared as listed in Table 1.

From the prepared foam samples, a selection were tested for combustion and the results are listed in Table 2.

A further selection of prepared foam samples were tested for compressibility and the results are listed in Table 3.

These data indicate that incorporation of a nanoclay material into a foam composition can result in a significant improvement of the fire retardant characteristic of the foam compared to foam which does not include nanoclay, while retaining the desirable mechanical properties of the foam material

Sample Formulation

| | | | | | | | | | | Cloisite | Lica | | |
|---|---|---|---|---|---|---|---|---|---|---|---|---|---|
| Sample | Poly- | Polyol | 33LV | BL11 | B4113 | DC5169 | Water | | Diisocyanate | 30b | 12 | Flame | % Flame |
| Identity | ol* | pbw | pbw | pbw | pbw | pbw | pbw | Diisocyanate** | pbw | pbw | pbw | Retardant | retardant |
| 5 | 428 | 100.00 | 0.40 | 0.043 | 0.585 | 0.500 | 3.60 | 2528 | 60.00 | 4.00 | | None | |
| 6 | 428 | 100.00 | 0.40 | 0.043 | 0.585 | 1.250 | 3.60 | 2528 | 60.00 | 4.00 | | None | |
| 7 | 428 | 100.00 | 0.40 | 0.043 | 0.585 | 0.000 | 3.60 | 2528 | 60.00 | 4.00 | | None | |
| 8 | 428 | 100.00 | 0.40 | 0.043 | 0.585 | 0.000 | 3.00 | 2528 | 60.00 | 4.00 | | None | |
| 9 | 428 | 100.00 | 0.40 | 0.043 | 0.585 | 0.000 | 3.00 | 2528 | 60.00 | 4.00 | | None | |
| 10 | 428 | 100.00 | 0.40 | 0.043 | 0.585 | 0.125 | 3.00 | 2528 | 60.00 | 5.00 | | None | |
| 11 | 436 | 100.00 | 0.40 | 0.043 | 0.585 | 0.125 | 3.50 | 2528 | 60.00 | 4.00 | | None | |
| 12 | 436 | 100.00 | 0.40 | 0.043 | 0.585 | 0.125 | 4.00 | 2528 | 60.00 | 4.00 | | None | |
| 13 | 436 | 100.00 | 0.41 | 0.042 | 0.667 | 0.125 | 4.00 | 2528 | 60.00 | 5.00 | | None | |
| 14 | 436 | 100.00 | 0.19 | 0.042 | 0.580 | 0.126 | 3.60 | 2528 | 60.00 | 4.00 | | None | |
| 15 | 436 | 100.00 | 0.19 | 0.042 | 0.580 | 0.126 | 3.60 | 2528 | 60.00 | 1.00 | | None | |
| 16 | 436 | 100.00 | 0.19 | 0.042 | 0.580 | 0.126 | 3.60 | 2528 | 60.00 | 2.00 | | None | |
| 17 | 436 | 100.00 | 0.19 | 0.042 | 0.580 | 0.126 | 3.60 | 2528 | 60.00 | 3.00 | | None | |
| 18 | 436 | 100.00 | 0.19 | 0.042 | 0.580 | 0.126 | 3.60 | 2528 | 60.00 | 6.00 | | None | |
| 19 | 436 | 100.00 | 0.19 | 0.040 | 0.580 | 0.124 | 6.00 | 2528 | 60.00 | 6.00 | | None | |
| 20 | 436 | 100.00 | 0.80 | 0.040 | 0.580 | 0.125 | 3.60 | 2528 | 60.00 | 6.00 | | None | |
| 21 | 436 | 100.00 | 0.80 | 0.040 | 0.580 | 2.000 | 3.60 | 2528 | 60.00 | 6.00 | | None | |
| 22 | 436 | 100.00 | 0.40 | 0.042 | 0.580 | 0.000 | 2.80 | 2528 | 60.00 | 6.00 | | None | |
| 23 | 436 | 100.00 | 0.40 | 0.042 | 0.580 | 0.000 | 2.80 | 2528 | 50.00 | 6.00 | | None | |
| 24 | 436 | 100.00 | 0.36 | 0.042 | 0.580 | 0.000 | 2.80 | 2528 | 50.00 | 6.00 | | None | |
| 25 | 436 | 100.00 | 0.36 | 0.042 | 0.580 | 0.000 | 3.20 | 2528 | 50.00 | 6.00 | | None | |
| 26 | 436 | 100.00 | 0.36 | 0.042 | 0.580 | 0.000 | 3.20 | 2528 | 50.00 | 6.00 | | None | |
| 27 | 436 | 100.00 | 0.26 | 0.042 | 0.580 | 0.060 | 3.60 | 2528 | 60.00 | 6.00 | | None | |
| 28 | 436 | 100.00 | 0.22 | 0.042 | 0.580 | 0.060 | 3.60 | 2528 | 60.00 | 6.00 | | None | |
| 29 | 436 | 100.00 | 0.32 | 0.042 | 0.583 | 0.067 | 3.60 | 2528 | 60.00 | 6.00 | | None | |
| 30 | 436 | 100.00 | 0.30 | 0.042 | 0.583 | 0.067 | 3.60 | 2528 | 60.00 | 5.00 | | None | |
| 30 | 436 | 100.00 | 0.30 | 0.042 | 0.580 | 0.060 | 3.60 | 2528 | 60.00 | 6.00 | | None | |
| 31 | 436 | 100.00 | 0.19 | 0.042 | 0.580 | 0.127 | 3.60 | 2528 | 60.00 | 4.00 | | None | |
| 32 | 436 | 100.00 | 0.30 | 0.042 | 0.580 | 0.300 | 3.60 | 2528 | 60.00 | 5.00 | | None | |
| 33 | 436 | 100.00 | 0.30 | 0.042 | 0.580 | 0.300 | 3.60 | 2528 | 40.00 | 5.00 | | None | |
| 34 | 436 | 100.00 | 0.30 | 0.042 | 0.580 | 0.300 | 3.60 | 2528 | 50.00 | 5.00 | | None | |
| 35 | 436 | 100.00 | 0.30 | 0.042 | 0.580 | 0.350 | 3.60 | 2528 | 60.00 | 6.00 | | None | |
| 36 | 436 | 100.00 | 0.32 | 0.042 | 0.580 | 0.383 | 3.60 | 2528 | 60.00 | 6.00 | | None | |
| 37 | 436 | 100.00 | 0.30 | 0.042 | 0.580 | 0.317 | 3.60 | 2528 | 60.00 | 6.00 | | None | |
| 40 | 436 | 100.00 | 0.30 | 0.042 | 0.580 | 0.350 | 3.60 | 2528 | 60.00 | 6.00 | 0.000 | None | |
| 41 | 436 | 100.00 | 0.30 | 0.042 | 0.580 | 0.350 | 3.60 | 2528 | 60.00 | 6.00 | 0.033 | None | |
| 42 | 436 | 100.00 | 0.30 | 0.042 | 0.580 | 0.350 | 3.60 | 2528 | 60.00 | 6.00 | 0.050 | None | |
| 43 | 436 | 100.00 | 0.30 | 0.042 | 0.580 | 0.350 | 3.60 | 2528 | 60.00 | 6.00 | 0.067 | None | |
| 44 | 436 | 100.00 | 0.30 | 0.042 | 0.580 | 0.350 | 3.60 | 2528 | 60.00 | 6.00 | 0.083 | None | |
| 45 | 436 | 100.00 | 0.30 | 0.042 | 0.580 | 0.350 | 3.60 | 2528 | 60.00 | 6.00 | 0.133 | None | |
| 46 | 436 | 100.00 | 0.19 | 0.042 | 0.580 | 0.127 | 3.60 | 2528 | 60.00 | 6.00 | | None | |
| 47 | 436 | 100.00 | 0.25 | 0.042 | 0.580 | 0.217 | 3.60 | 2528 | 60.00 | 6.00 | | None | |
| 48 | 436 | 100.00 | 0.19 | 0.042 | 0.580 | 0.137 | 3.60 | 2528 | 60.00 | 6.00 | | None | |
| 49 | 436 | 100.00 | 0.30 | 0.042 | 0.580 | 0.135 | 3.60 | 2528 | 60.00 | 6.00 | | None | |
| 50 | 436 | 100.00 | 0.30 | 0.042 | 0.580 | 0.500 | 3.60 | 2528 | 60.00 | 6.00 | | None | |
| 51 | 436 | 100.00 | 0.40 | 0.042 | 0.580 | 0.500 | 0.00 | 2528 | 60.00 | 6.00 | | None | |
| 52 | 436 | 100.00 | 0.40 | 0.042 | 0.580 | 0.500 | 3.60 | 2528 | 60.00 | 6.00 | | None | |
| 53 | 436 | 100.00 | 0.47 | 0.042 | 0.580 | 0.533 | 3.60 | 2528 | 60.00 | 8.00 | | None | |
| 54 | 436 | 100.00 | 0.53 | 0.042 | 0.580 | 0.533 | 3.60 | 2528 | 60.00 | 8.00 | | None | |
| 55 | 436 | 100.00 | 0.57 | 0.042 | 0.580 | 0.800 | 3.60 | 2528 | 60.00 | 8.00 | | None | |
| 56 | 436 | 100.00 | 0.70 | 0.042 | 0.580 | 0.567 | 3.60 | 2528 | 60.00 | 8.00 | | None | |
| 57 | 436 | 100.00 | 0.70 | 0.040 | 0.580 | 0.560 | 3.60 | 2528 | 60.00 | 8.00 | | None | |
| 58 | 436 | 100.00 | 0.70 | 0.042 | 0.580 | 0.567 | 3.60 | 2528 | 60.00 | 8.00 | | None | |
| 59 | 436 | 100.00 | 0.70 | 0.040 | 0.580 | 0.560 | 3.60 | 2528 | 60.00 | 8.00 | 0.160 | Melamine | 2.81 |
| 60 | 436 | 100.00 | 0.70 | 0.040 | 0.580 | 0.560 | 3.60 | 2528 | 60.00 | 8.00 | 0.160 | Melamine | 5.47 |
| 61 | 436 | 100.00 | 0.70 | 0.040 | 0.580 | 0.560 | 3.60 | 2528 | 60.00 | 8.00 | 0.160 | Melamine | 2.81 |
| 62 | 436 | 100.00 | 0.70 | 0.040 | 0.580 | 0.560 | 3.60 | 2528 | 60.00 | 8.00 | 0.160 | Melamine | 7.98 |
| 63 | 436 | 100.00 | 0.70 | 0.040 | 0.580 | 0.560 | 3.60 | 2528 | 60.00 | 8.00 | 0.160 | None | |
| 64 | 436 | 100.00 | 0.70 | 0.040 | 0.580 | 0.560 | 3.60 | 2528 | 60.00 | 8.00 | 0.160 | None | |
| 65 | 436 | 100.00 | 0.70 | 0.040 | 0.580 | 0.560 | 3.60 | 2528 | 60.00 | 8.00 | 0.160 | None | |
| 66 | 436 | 100.00 | 0.70 | 0.040 | 0.580 | 0.560 | 3.60 | 2528 | 60.00 | 8.00 | 0.160 | None | |
| 67 | 436 | 100.00 | 0.70 | 0.040 | 0.580 | 0.560 | 3.60 | 2528 | 60.00 | 8.00 | 0.160 | None | |
| 68 | 436 | 100.00 | 0.70 | 0.040 | 0.580 | 0.560 | 3.60 | 2528 | 60.00 | 8.00 | 0.160 | None | |
| 69 | 436 | 100.00 | 0.70 | 0.040 | 0.580 | 0.560 | 3.60 | 2528 | 60.00 | 8.00 | 0.160 | Melamine | 10.37 |
| 70 | 436 | 100.00 | 0.70 | 0.040 | 0.580 | 0.560 | 3.60 | 2528 | 60.00 | 0.00 | 0.000 | None | |
| 71 | 436 | 100.00 | 0.70 | 0.040 | 0.580 | 0.560 | 3.60 | 2528 | 60.00 | 2.00 | 0.040 | None | |
| 72 | 436 | 100.00 | 0.70 | 0.040 | 0.580 | 0.560 | 3.60 | 2528 | 60.00 | 4.00 | 0.080 | None | |
| 73 | 436 | 100.00 | 0.70 | 0.040 | 0.580 | 0.560 | 3.60 | 2528 | 60.00 | 8.00 | 0.160 | None | |
| 74 | 436 | 100.00 | 0.70 | 0.040 | 0.580 | 0.560 | 3.60 | 2528 | 60.00 | 10.00 | 0.200 | None | |
| 75 | 436 | 100.00 | 0.70 | 0.040 | 0.580 | 0.560 | 3.60 | 2528 | 60.00 | 8.00 | 0.160 | None | |
| 76 | 436 | 100.00 | 0.70 | 0.040 | 0.580 | 0.560 | 3.60 | 2528 | 60.00 | 8.00 | 0.160 | None | |
| 77 | 436 | 100.00 | 0.70 | 0.040 | 0.580 | 0.560 | 3.60 | 2528 | 60.00 | 8.00 | 0.200 | None | |
| 78 | 436 | 100.00 | 0.84 | 0.040 | 0.580 | 0.560 | 3.60 | 2528 | 60.00 | 8.00 | 0.240 | None | |
| 81 | 436 | 100.00 | 0.70 | 0.040 | 0.580 | 0.560 | 3.60 | 2528 | 60.00 | 2.00 | 0.040 | None | |
| 82 | 436 | 100.00 | 0.70 | 0.040 | 0.580 | 0.560 | 3.60 | 2528 | 60.00 | 3.00 | 0.060 | None | |
| 83 | 436 | 100.00 | 0.70 | 0.040 | 0.580 | 0.560 | 3.60 | 2528 | 60.00 | 4.00 | 0.080 | None | |
| 84 | 436 | 100.00 | 0.70 | 0.040 | 0.580 | 0.560 | 3.60 | 2528 | 60.00 | 5.00 | 0.140 | None | |
| 85 | 436 | 100.00 | 0.80 | 0.040 | 0.580 | 0.560 | 3.60 | 2528 | 60.00 | 6.00 | 0.140 | None | |
| 86 | 436 | 100.00 | 0.84 | 0.040 | 0.620 | 0.560 | 3.60 | 2528 | 60.00 | 8.00 | 0.160 | None | 0.00 |
| 87 | 436 | 100.00 | 0.80 | 0.040 | 0.580 | 0.560 | 3.60 | 2528 | 60.00 | 8.00 | 0.160 | None | 0.00 |
| 88 | 436 | 100.00 | 0.80 | 0.040 | 0.580 | 0.560 | 3.60 | 2528 | 60.00 | 6.00 | 0.160 | None | 0.00 |
| 89 | 436 | 100.00 | 0.80 | 0.040 | 0.580 | 0.560 | 3.60 | 2528 | 60.00 | 8.00 | 0.160 | None | 0.00 |
| 90 | 436 | 100.00 | 0.80 | 0.040 | 0.580 | 0.560 | 3.60 | 2528 | 60.00 | 0.00 | 0.140 | Triphenyl phosphate | 2.37 |
| 91 | 436 | 100.00 | 0.80 | 0.040 | 0.580 | 0.560 | 3.60 | 2528 | 60.00 | 0.00 | 0.140 | Triphenyl phosphate | 4.62 |
| 92 | 436 | 100.00 | 0.80 | 0.040 | 0.580 | 0.560 | 3.60 | 2528 | 60.00 | 0.00 | 0.140 | Triphenyl phosphate | 6.78 |
| 93 | 436 | 100.00 | 0.80 | 0.040 | 0.580 | 0.560 | 3.60 | 2528 | 60.00 | 6.00 | 0.140 | Triphenyl phosphate | 6.56 |
| 94 | 436 | 100.00 | 0.80 | 0.040 | 0.580 | 0.560 | 3.60 | 2528 | 60.00 | 6.00 | 0.140 | Triphenyl phosphate | 10.47 |
| 95 | 436 | 100.00 | 0.80 | 0.040 | 0.580 | 0.560 | 3.60 | 2528 | 60.00 | 9.00 | 0.140 | Triphenyl phosphate | 10.31 |
| 100 | 428 | 100.00 | 0.70 | 0.040 | 0.580 | 0.560 | 3.60 | 2528 | 60.00 | 0.00 | 0.000 | None | 0.00 |
| 101 | 428 | 100.00 | 0.70 | 0.040 | 0.580 | 0.560 | 3.60 | 2528 | 60.00 | 2.00 | 0.040 | None | 0.00 |
| 102 | 428 | 100.00 | 0.80 | 0.040 | 0.580 | 0.560 | 3.60 | 2528 | 60.00 | 8.00 | 0.200 | None | 0.00 |
| 103 | 428 | 100.00 | 0.80 | 0.040 | 0.580 | 0.560 | 3.60 | 2528 | 60.00 | 8.00 | 0.200 | None | 0.00 |
| 104 | 428 | 100.00 | 0.70 | 0.040 | 0.580 | 0.560 | 3.60 | 2528 | 60.00 | 6.00 | 0.160 | None | 0.00 |
| 105 | 428 | 100.00 | 0.70 | 0.040 | 0.580 | 0.560 | 3.60 | 2528 | 60.00 | 6.00 | 0.160 | None | 0.00 |
| 106 | 428 | 100.00 | 0.70 | 0.040 | 0.580 | 0.560 | 3.60 | 2528 | 60.00 | 0.00 | 0.000 | Reofos NTP | 5.72 |
| 107 | 428 | 100.00 | 0.70 | 0.040 | 0.580 | 0.560 | 3.60 | 2528 | 60.00 | 2.00 | 0.040 | Reofos NTP | 5.65 |
| 108 | 428 | 100.00 | 0.70 | 0.040 | 0.580 | 0.560 | 3.60 | 2528 | 60.00 | 4.00 | 0.080 | Reofos NTP | 5.59 |
| 109 | 428 | 100.00 | 0.80 | 0.040 | 0.580 | 0.560 | 3.60 | 2528 | 60.00 | 6.00 | 0.160 | Reofos NTP | 5.52 |
| 110 | 428 | 100.00 | 0.90 | 0.040 | 0.580 | 0.560 | 3.60 | 2528 | 60.00 | 8.00 | 0.200 | Reofos NTP | 5.46 |
| 111 | 428 | 100.00 | 0.80 | 0.040 | 0.580 | 0.560 | 3.60 | 2528 | 60.00 | 6.00 | 0.160 | Reofos NTP | 5.52 |
| 112 | 428 | 100.00 | 0.80 | 0.040 | 0.580 | 0.560 | 3.60 | 2528 | 60.00 | 6.00 | 0.160 | Reofos NTP | 5.52 |
| 124 | 428 | 100.00 | 0.70 | 0.040 | 0.580 | 0.560 | 3.60 | 2528 | 60.00 | 8.00 | 0.160 | None | 0.00 |
| 125 | 428 | 100.00 | 0.70 | 0.040 | 0.580 | 0.560 | 3.60 | 2528 | 60.00 | 8.00 | 0.160 | Melamine | 14.78 |
| 126 | 428 | 100.00 | 0.70 | 0.040 | 0.580 | 0.560 | 3.60 | 2528 | 60.00 | 0.00 | 0.000 | None | 0.00 |
| 127 | 428 | 100.00 | 0.70 | 0.040 | 0.580 | 0.560 | 3.60 | 2528 | 60.00 | 8.00 | 0.160 | Melamine | 14.78 |
| 128 | 428 | 100.00 | 0.70 | 0.040 | 0.580 | 0.560 | 3.60 | 2528 | 60.00 | 8.00 | 0.160 | Melamine | 14.78 |
| 129 | 428 | 100.00 | 0.70 | 0.040 | 0.580 | 0.560 | 3.60 | 2528 | 60.00 | 10.00 | 0.200 | Melamine | 14.64 |
| 130 | 428 | 100.00 | 0.70 | 0.040 | 0.580 | 0.560 | 3.60 | 2528 | 60.00 | 10.00 | 0.200 | Melamine | 14.64 |
| 131 | 428 | 100.00 | 0.70 | 0.040 | 0.580 | 0.560 | 3.60 | 2528 | 60.00 | 0.00 | 0.000 | Melamine | 10.82 |
| 132 | 428 | 100.00 | 0.70 | 0.040 | 0.580 | 0.560 | 3.60 | 2528 | 60.00 | 8.00 | 0.160 | Melamine | 14.78 |
| 133 | 428 | 100.00 | 0.70 | 0.040 | 0.580 | 0.560 | 3.60 | 2528 | 60.00 | 8.00 | 0.160 | Melamine | 12.19 |
| 134 | 428 | 100.00 | 0.70 | 0.040 | 0.580 | 0.560 | 3.60 | 2528 | 60.00 | 8.00 | 0.160 | Melamine | 13.07 |
| 113 | 428 | 100.00 | 0.80 | 0.040 | 0.580 | 0.560 | 3.60 | 2528 | 60.00 | 6.00 | 0.160 | Reofos NTP | 5.52 |
| 114 | 428 | 100.00 | 0.70 | 0.040 | 0.580 | 0.560 | 3.60 | 2528 | 60.00 | 8.00 | 0.160 | Melamine | 4.42 |
| 115 | 428 | 100.00 | 0.70 | 0.040 | 0.580 | 0.560 | 3.60 | 2528 | 60.00 | 8.00 | 0.160 | Melamine | 14.78 |
| 116 | 428 | 100.00 | 0.70 | 0.040 | 0.580 | 0.560 | 3.60 | 2528 | 60.00 | 8.00 | 0.160 | Melamine | 18.79 |
| 117 | 428 | 100.00 | 0.70 | 0.040 | 0.580 | 0.560 | 3.60 | 2528 | 60.00 | 0.00 | 0.000 | None | 0.00 |
| 118 | 428 | 100.00 | 0.70 | 0.040 | 0.580 | 0.560 | 3.60 | 2528 | 60.00 | 0.00 | 0.000 | Melamine | 15.39 |
| 119 | 428 | 100.00 | 0.70 | 0.040 | 0.580 | 0.560 | 3.60 | 2528 | 60.00 | 8.00 | 0.160 | None | 0.00 |
| 120 | 428 | 100.00 | 0.80 | 0.040 | 0.580 | 0.560 | 3.60 | 2528 | 60.00 | 8.00 | 0.160 | Melamine | 14.78 |
| 121 | 428 | 100.00 | 0.70 | 0.040 | 0.580 | 0.560 | 3.60 | 2528 | 60.00 | 6.40 | 0.120 | Melamine | 10.45 |
| 122 | 428 | 100.00 | 0.70 | 0.040 | 0.580 | 0.560 | 3.60 | 2528 | 60.00 | 0.00 | 0.000 | None | 0.00 |
| 123 | 428 | 100.00 | 0.70 | 0.040 | 0.580 | 0.560 | 3.60 | 2528 | 60.00 | 0.00 | 0.000 | Melamine | 15.39 |
| 136 | 428 | 100.00 | 0.70 | 0.040 | 0.580 | 0.560 | 3.60 | 2528 | 60.00 | 8.00 | 0.160 | Melamine | 13.94 |
| 137 | 428 | 100.00 | 0.70 | 0.040 | 0.580 | 0.560 | 3.60 | 2528 | 60.00 | 8.00 | 0.160 | Aluminium | 2.81 |
| | | | | | | | | | | | | trihydrate | |
| 138 | 428 | 100.00 | 0.70 | 0.040 | 0.580 | 0.560 | 3.60 | 2528 | 60.00 | 8.00 | 0.160 | Aluminium | 5.47 |
| | | | | | | | | | | | | trihydrate | |
| 139 | 428 | 100.00 | 0.70 | 0.040 | 0.580 | 0.560 | 3.60 | 2528 | 60.00 | 8.00 | 0.160 | Aluminium | 12.19 |
| | | | | | | | | | | | | trihydrate | |
| 140 | 428 | 100.00 | 0.70 | 0.040 | 0.580 | 0.560 | 3.60 | 2528 | 60.00 | 10.00 | 0.200 | Aluminium | 6.42 |
| | | | | | | | | | | | | trihydrate | |
| 141 | 428 | 100.00 | 0.70 | 0.040 | 0.580 | 0.560 | 3.60 | 2528 | 60.00 | 8.00 | 0.160 | Aluminium | 20.65 |
| | | | | | | | | | | | | trihydrate | |
| 142 | 428 | 100.00 | 0.70 | 0.044 | 0.580 | 0.560 | 3.60 | 2528 | 60.00 | 8.00 | 0.160 | Aluminium | 18.79 |
| | | | | | | | | | | | | trihydrate | |
| 143 | 428 | 100.00 | 0.70 | 0.040 | 0.580 | 0.560 | 3.60 | 2528 | 60.00 | 8.00 | 0.160 | Aluminium | 22.43 |
| | | | | | | | | | | | | trihydrate | |
| 200 | 428 | 100.00 | 0.50 | 0.040 | 0.620 | 0.560 | 3.60 | TDI | 30.40 | 0.00 | 0.000 | None | 0.00 |
| 201 | 428 | 100.00 | 0.50 | 0.040 | 0.600 | 0.560 | 3.60 | TDI | 30.40 | 0.00 | 0.000 | None | 0.00 |
| 202 | 428 | 100.00 | 0.70 | 0.040 | 0.580 | 0.560 | 3.60 | TDI | 30.40 | 8.00 | 0.160 | None | 0.00 |
| 203 | 428 | 100.00 | 0.60 | 0.040 | 0.600 | 0.520 | 3.00 | TDI | 30.40 | 8.00 | 0.160 | None | 0.00 |
| 204 | 428 | 100.00 | 0.72 | 0.040 | 0.600 | 0.520 | 3.00 | TDI | 30.40 | 8.00 | 0.160 | None | 0.00 |
| 205 | 428 | 100.00 | 0.90 | 0.040 | 0.600 | 0.520 | 3.00 | TDI | 32.00 | 8.00 | 0.160 | None | 0.00 |
| 206 | 428 | 100.00 | 0.90 | 0.040 | 0.600 | 0.560 | 3.00 | TDI | 32.00 | 8.00 | 0.160 | Melamine | 15.25 |
| 207 | 428 | 100.00 | 0.90 | 0.040 | 0.600 | 0.560 | 3.00 | TDI | 32.00 | 8.00 | 0.160 | Melamine | 15.25 |

1. A mixture for use in forming a foamed polyurethane, said mixture comprising components necessary for forming a polyurethane foamed material, clay particles and at least one coupling agent.

2. A mixture according to claim 1, wherein the components necessary for forming a foamed polyurethane comprise at least one polyol and/or amine, an isocyanate, a catalyst, a surfactant and water and/or a blowing agent.

3. A mixture according to claim 1 which further comprises a char promoting agent and/or fire retardant.

4. A mixture according to claim 3, wherein the char promoting agent is selected from the group consisting of melamine, ammonium polyphosphate, trichloropropyl phosphate (TCPP), triethyl phosphate (TEP), diethyl ethyl phosphate (DEEP) and diethyl bis(2 hydroxyethyl)amino methyl phosphonate.

5. A mixture according to claim 3, wherein the fire retardant is selected from the group consisting of brominated phthalic anhydride based ester, dibromoneopentyl glycol, brominated polyether polyol and aluminium trihydrate.

6. A mixture according to claim 1, wherein the clay particles are selected from the group consisting of smectite, vermiculite or halloysite clays.

7. A mixture according to claim 6, wherein the smectite type of clay is selected from the group consisting of montmorillonite, saponite, beidellite, nontrite, and hectorite.

8. A mixture according to claim 7, wherein the montmorillonite clay is an aluminosilicate clay of formula:
M⁺_{y}(Al_{2-y}Mg_{y})(Si₄)O₁₀(OH)₂nH₂O

9. A mixture according to claim 1, wherein the amount of clay particles is between above 0 to about 20% by weight of the total mixture weight.

10. A mixture according to claim 9, wherein the amount of clay is from about 0.1% to about 15% by weight of the total mixture weight.

11. A mixture according to claim 10, wherein the amount of clay is from about 1% to about 10% by weight of the total mixture weight.

12. A mixture according to claim 1, wherein the clay particles are clay minerals which have undergone a cation exchange with at least one cationic organic species.

13. A mixture according to claim 12, where the cationic organic species comprises a quarternary ammonium ion species or an onium species.

14. A mixture according to claim 13, wherein the quaternary ammonium ion species is an alkyl ammonium ion.

15. A mixture according to claim 14, wherein the alkyl ammonium ion is selected from the group consisting of dimethyl dihydrogenatedtallow ammonium of formula: 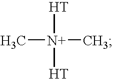
dimethyl benzylhydrogenatedtallow ammonium of formula: 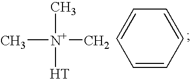
dimethyl hydrogenatedtallow (2-ethylhexyl)ammonium of formula: 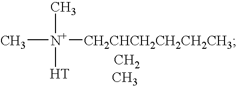
and methyl bis 2-hydroxylethyl ammonium of formula: 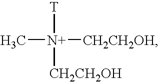
where, in each of the above formulae, T=tallow and HT=hydrogenatedtallow having a chain length with an approximate content of 65% C₁₈, 30% C₁₆ and 5% C₁₄.

16. A mixture according to claim 1, wherein the coupling agent comprises a neoalkoxy titanate agent or neoalkoxy zirconate agent.

17. A mixture according to claim 16, wherein the neoalkoxy titanate agent is neopentyl(diallyl)oxy tri(dioctyl)phosphate titanate of formula (I):

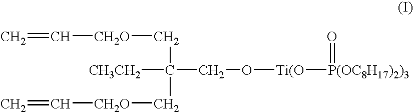

18. A mixture according to claim 1, wherein the coupling agent is incorporated at an amount of above 0 to about 10% by weight of the total mixture weight.

19. A mixture according to claim 1, wherein the amount of coupling agent is from about 0.001% to about 6% of the weight of the clay in the total mixture.

20. A mixture according to claim 19, wherein the amount of coupling agent is foam about 0.005 to 2% of the weight of the clay in the total mixture.

21. A flexible foam material comprising a polyurethane composite material, wherein the polyurethane composite material comprises exfoliated clay particles dispersed therein and at least one coupling agent.

22. A flexible foam material according to claim 21, which is an open-celled flexible product obtainable by reacting a polyisocyanate with isocyanate-reactive hydrogen containing compounds and a foaming agent.

23. A flexible foam material according to claim 22, wherein the foaming agent is carbon dioxide.

24. A flexible foam material according to claim 21, wherein the isocyanate reactive compounds are chosen from polyols, aminoalcohols and/or polyamines.

25. A flexible foam material according to claim 21 wherein the polyol is selected from the group consisting of reaction products of alkylene oxide; polyesters obtained by the condensation of glycols and higher functionality polyols with polycarboxylic acids; hydroxyl terminated polythioethers; polyamides; polyesteramides; polycarbonates; polyacetals; and polysiloxanes.

26. A flexible foam material according to claim 21, wherein the isocyanate-reactive compounds are selected from the group consisting of ethylene glycol, diethylene glycol, propylene glycol, dipropylene glycol, butane diol, glycerol, trimethylolpropane, ethylene diamine, ethanolamine, diethanolamine, triethanolamine, pentaerythritol, sorbitol, sucrose, polyamines such as ethylene diamine, tolylene diamine, diaminodiphenylmethane and polymethylene polyphenylene polyamines, and aminoalcohols such as ethanolamine and diethanolamine and mixtures thereof.

27. A flexible foam material according to claim 21, which is a flexible polyurethane foam prepared by reacting a polyisocyanate with a polyester or polyether polyol, in the presence of a blowing agent and including an additive such as a catalyst, surfactant, fire retardant, stabiliser and/or antioxidant.

28. A flexible foam material according to claim 27, wherein the surfactant is a polyoxyalkylene polysiloxane copolymer.

29. A flexible foam material according to claim 27, wherein the polyisocyanate is selected from the group consisting of aliphatic, cycloaliphatic, aryl-aliphatic and aromatic polyisocyanates.

30. A flexible foam material according to claim 29, wherein the aromatic polyisocyanate is selected from the group consisting of toluene diisocyanate, diphenylmethane diisocyanate, polymeric isocyanates and isocyanurates thereof, and mixtures thereof, including oligomers thereof.

31. A moulded foam or slabstock foam comprising the flexible foam material of claim 21.

32. A cushioning material for use in furniture, automotive seating, mattresses, carpet backing, foam in diapers, packaging foam, and/or sound insulation foam comprising the moulded foam or slabstock foam of claim 31.

33. A method of making a flexible foam material comprising:
providing a mixture comprising components required for forming a foamed polyurethane, clay particles for dispersion within said foamed polyurethane and at least one coupling agent; and forming the mixture into a flexible foam material.

34. A method according to claim 33, wherein the mixture comprises components necessary for forming a polyurethane foamed material, clay particles and at least one coupling agent, wherein the components necessary for forming a foamed polyurethane comprise at least one polyol and/or amine, an isocyanate, a catalyst, a surfactant and water and/or a blowing agent.

35. A method according to claim 33, wherein the clay material is subjected to high shear mixing with at least one of the components required for forming the foamed polyurethane.

36. A method according to claim 33, wherein ultrasound is used in the presence or absence of mechanical stirring, to disperse the clay particles within the foam composition into an exfoliated state.

37. A method according to claim 36, wherein the ultrasound is applied as high frequency ultrasound.

38. A method according to claim 37, wherein the ultrasound frequency is in the range of 1 kHz to 10 MHz.

39. A method according to claim 36, wherein the ultrasound is applied for a period of time of from 10 seconds to 30 minutes.

40. A method according to claim 39, wherein the ultrasound is applied for a period of time of from 30 seconds to 20 minutes.

41. A method according to claim 33, wherein microwaves, infrared radiation or other electromagnetic radiation is used to disperse the clay particles within the foam composition into an exfoliated state.

42. A process for preparing a pre-polyurethane composition comprising the steps of:
providing a polyol,
introducing a clay material into the polyol and applying ultrasound to form a dispersed mixture, and
introducing water, a polyisocyanate and optionally at least one coupling agent into said dispersed mixture to form a final prefoamed polyurethane composition.

43. A process according to claim 42, wherein, following formation of the final prefoamed polyurethane composition the composition is allowed to polymerise and form a polyurethane foam nanocomposite material.

44. A process according to claim 43, wherein, following foam formation, the foam is allowed to cure to form a final polyurethane foam nanocomposite material.

45. A process according to claim 42, wherein the water is added before, at the same time, or after the introduction of the polyisocyanate.

46. A process according to claim 42, wherein the combination of components is mechanically mixed prior to foam formation.

47. A process according to claim 42, wherein, prior to forming the foam nanocomposite material, the prefoamed polyurethane composition is introduced into a mould to contain the composition during foam formation, or allowed to form a free foaming slab.

48. A process according to claim 47, wherein at least one of the mixing steps is carried out simultaneously with the introduction of the composition into the mould or into a free foaming slab form.

49. A process according to claim 47, wherein the composition is introduced into the mould or slab forming structure by means of a reaction injection moulding device.

50. A process according to claim 42, wherein a coupling agent is introduced during the preparation process.

51. A process according to claim 50, wherein the coupling agent is provided in the polyol containing mixture.

52. A process according to claim 42, wherein the composition additionally contains other additives, selected from the group consisting of catalysts, surfactants, flame retarding agents, stabilisers, colourants and antioxidants.

53. A process according to claim 52, wherein the other additives are provided in the polyol containing mixture.

54. A process according to claim 42, wherein the mixture to which the ultrasound is applied is stirred and cooled during the application of the ultrasound.

55. A means for preparing a prefoaming-polyurethane composition, comprising a first chamber or region (A) into which is introduced a polyol and clay particles, and
optionally a coupling agent and/or other additives, and wherein ultrasound, and optionally mechanical stirring, is applied to the mixture to disperse the clay particles; and optionally a second chamber or region into which the resultant mixture from the first chamber or region (A) is moved, and water and an isocyanate added in an appropriate order, with optional mechanical mixing to form the prefoaming-polyurethane composition.

56. A means according to claim 55, comprising a mixing head in which all reactants are mixed simultaneously and ultrasound or other suitable dispersing energy applied.

57. A means according to claim 55, further comprising an ultrasound generating probe for delivering ultrasound.

58. A polyurethane foam material obtainable by the process according to claim 42.

59. A polyurethane foam material obtainable from a mixture as defined in claim 1.

60. Use of a clay material as a fire retardant in a polyurethane nanoclay foam composite or foam nanocomposite material.

61. A polyurethane foam material obtainable by use of the means of claim 54.
